(19) United States
(12) Patent Application Publication
(10) Pub. No.: US 2008/0121340 A1
(43) Pub. Date: May 29, 2008

(54) Foam imprinting method

(76) Inventor: Meng-Chieh Lin, Feng-Yuan City (TW)

Correspondence Address: CHARLES E. BAXLEY, ESQ., 90 JOHN STREET, THIRD FLOOR, NEW YORK, NY, 10038, US

(21) Appl. No.: 11/594,670

(22) Filed: Nov. 8, 2006

(51) Int. Cl. B32B 38/14

(52) U.S. Cl. 156/247

(57) ABSTRACT

In a foam imprinting method, a foam material and a mesh fabric material having messes are prepared; a foaming process is performed and a printing ink layer is coated onto the mesh fabric material when the foam material is not foamed completely, such that the printing ink layer is stacked onto the incompletely foamed material; the foam material, mesh fabric material, and printing ink layer are thermally pressed, and the incompletely foamed material continues its foaming to form protrusions on the meshes, and the printing ink layer is sublimated and permeated into the foam material to complete the imprint. After the mesh fabric material is torn away, a three-dimensional non-slip pattern is formed on the foam material to produce a product with the imprint pattern. The pattern and color of the printing ink layer will not fall off or peeled easily.

### BACKGROUND OF THE INVENTION

1. Field of the Invention

The present invention relates to a foam printing method, and more particularly to a breakthrough of an imprinting technology that can imprint a foam mat with a long-lasting effect, so that the imprinted pattern and color will not fade easily.

2. Background of the Invention

In general, foam mats are used extensively for our exercises and daily products and applicable for yoga exercises and non-slip mats, etc. The products made of a foam material and printed with a pattern can- attract consumers of different age groups, and most methods used for printing the patterns are imprinting methods.

In a structure and a method for imprinting a sticker as disclosed in R.O.C. Pat. Publication No. 296359, a layer of hot melt glue is coated onto a release paper, and a layer of transparent paint is coated onto the hot melt glue after the hot melt glue is dried, a color ink is used for printing a pattern or decorative design on the transparent paint after the transparent paint is dried, and then a layer of transparent paint is coated onto the dried color ink again, so that the color ink is covered by both transparent paints. After the transparent paint is dried, a transparent transfer film is attached onto the outermost layer of transparent paint to constitute a sticker.

When the sticker is used, the release paper is torn away, so that the hot melt glue can stick the sticker onto an object such as a mat, and then the transparent transfer film is torn away and the color ink is remained and imprinted onto the object or the mat.

In the transferring or imprinting method as described above, the objects made of a foam material still have certain problems. Since adhesives such as hot melt glues are used for attaching objects, the imprint is accomplished by pressing the transparent transfer film, and the foam material is an elastic porous material, the imprinting effect can be applied to the surface of a foam material only. After the foam material has been used for a period of time and gone through the pulling and contracting forces for many times, the color ink will be deformed, cracked, peeled or separated to an extent according to the pulling and contracting force on the porous foam material due to the external pressure on the elastic foam material. However, the color ink on the surface of the foam material is consisted of rigid color particles, and its contractibility cannot be compared with the foam material, and thus causing the peel. Once the color ink is peeled off, the pattern will become deformed and mottled, and the original artistic pattern will be ruined.

### SUMMARY OF THE INVENTION

In view of the shortcomings of the prior art, the inventor of the invention based on years of experience in the related industry to conduct extensive researches and experiments, and finally invented a foam imprinting method in accordance with the present invention.

Therefore, it is a primary objective of the present invention to provide a feasible solution and overcome the foregoing problems by providing a foam imprinting method that differs from the traditional surface connecting method used for imprinting. In the present invention, a hot pressing color ink is penetrated into the porous tissue of a foam material, so that the color ink pattern will not fall off or peel off easily, and it can maintain the artistic imprinted pattern.

To achieve the foregoing objective, the present invention provides a foam imprinting method comprising the following steps:

Material Preparation: A foam material and a mesh fabric material having a plurality of meshes disposed on the mesh fabric material are prepared, and the portion having no meshes is a sealed fabric surface;

Pre-foaming: The foam material is foamed till it is not fully foamed;

Printing ink layer: A printing ink layer is coated onto a fabric surface at a side of the mesh fabric material facing the foam material;

Hot Pressing: The foam material, mesh fabric material and printing ink layer are hot pressed, such that the printing ink layer is sublimated, permeated and imprinted onto the foam material, and protrusions are formed at the meshes of the foam material due to the foaming; and

Tearing Away Mesh Fabric Material: The mesh fabric material is torn away from the foam material after the printing ink layer is imprinted, so as to complete the process of imprinting a pattern onto the foam material.

Therefore, the technical measures taken by the present invention can achieve the following effects:

1. The invention changes the prior art method of using adhesives to connect the surface layers to cope with the elastic foam material, so that the printing ink layer can be in direct contact with the foam material, and a thermal sublimation occurs during the hot pressing process, such that the molecules of the printing ink layer can achieve the effect of imprinting the foam material through the permeation. Unlike the traditional method of connecting the surface layers, the color ink molecules of the printing ink layer are permeated and filled into the porous tissues of the foam material, so as to achieve the secured imprinting effect for the printing ink layer.

2. The meshes of the mesh fabric allow the foam material to be foamed to form protrusions, such that the invention not only provides non-slip protrusions for the slippery resisting effect, but also gives an artistic printing ink layer.

3. As the foam material is pulled, contracted or deformed, the printing ink layer will be pulled, contracted or deformed accordingly due to the permeation, and thus the printing ink layer will not fall off or peel off. The invention overcomes the foregoing shortcomings of the prior art, and also can maintain the artistic oil ink pattern.

### BRIEF DESCRIPTION OF THE DRAWINGS

The objective, shape, structure, characteristic and effect of the present invention will now be described in more detail with reference to the accompanying drawings that show various embodiments of the invention, in which:

FIG. 1 is a schematic block diagram showing a flow chart of the present invention;

FIG. 2 is an exploded view of a foam material and a mesh fabric material of the present invention;

FIG. 3 is a cross-sectional view of connecting a mesh fabric material with a printing ink layer according to the first embodiment of the present invention;

FIG. 4 is a cross-sectional view of stacking a foam material, a mesh fabric material and a printing ink layer according to the first embodiment of the present invention;

FIG. 5 is a cross-sectional view showing a foaming process of the first embodiment of the present invention;

FIG. 6 is a cross-sectional view of tearing away a mesh fabric material after the hot pressing foaming process is completed according to the first embodiment of the present invention;

FIG. 7 is a perspective view of the first embodiment of the present invention;

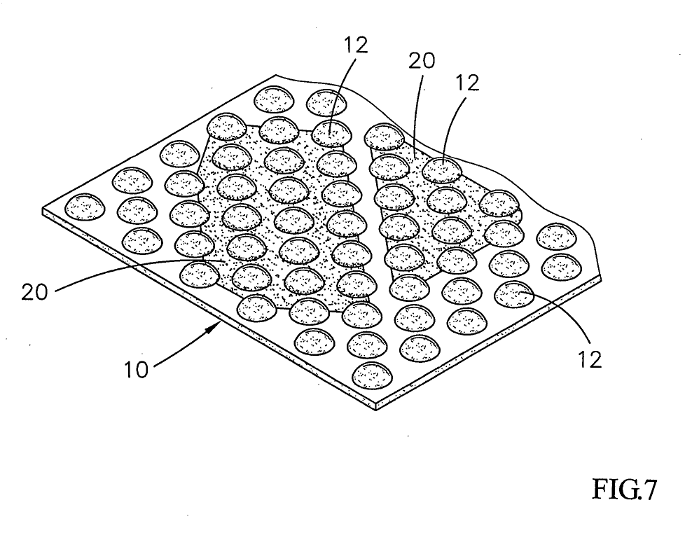

FIG. 8 is a cross-sectional view of connecting a mesh fabric material with a printing ink layer according to the second embodiment of the present invention;

FIG. 9 is a cross-sectional view of stacking a foam material, a mesh fabric material and a printing ink layer according to the second embodiment of the present invention;

FIG. 10 is a cross-sectional view showing a foaming process of the second embodiment of the present invention;

FIG. 11 is a cross-sectional view of tearing away a mesh fabric material after the hot pressing foaming process is completed according to the second embodiment of the present invention, and

FIG. 12 is a perspective view of the second embodiment of the present invention.

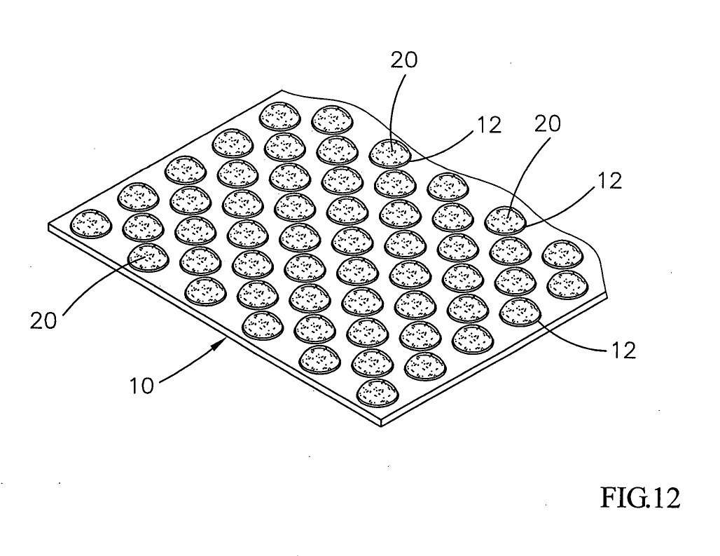

### DETAILED DESCRIPTION OF THE PREFERRED EMBODIMENTS

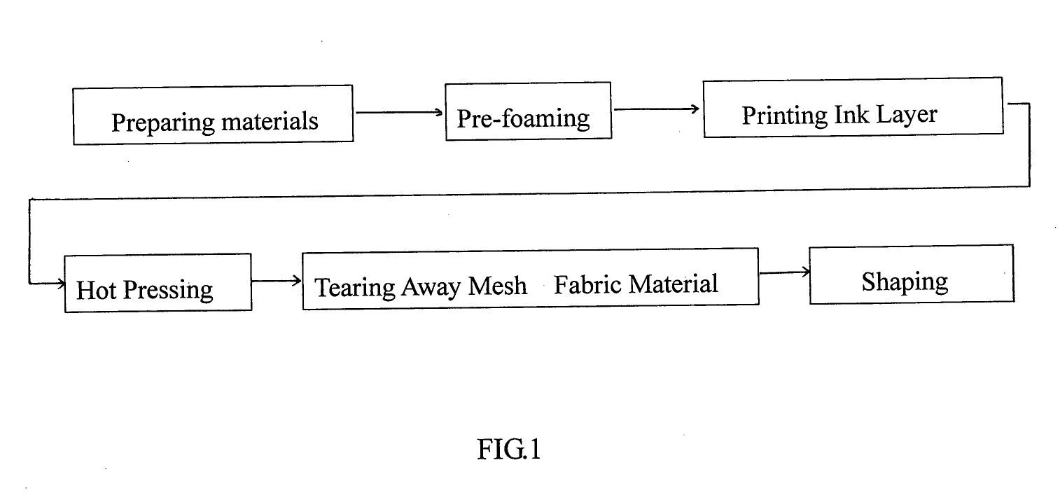

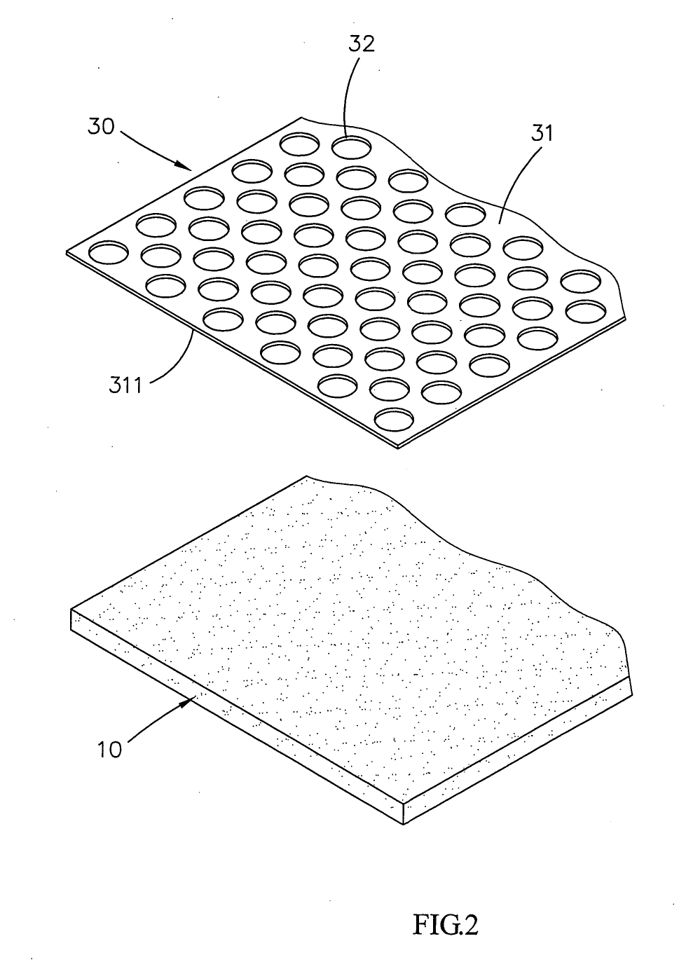

Referring to FIGS. 1 and 2 for a foam imprinting method of the present invention, the flow of the method of the invention is described as follows.

Preparing materials: a foam material 10 such as ethyl vinyl acetate (EVA), thermal plastic elastomer (TPE), polyurethane (PU) or styrene (SBR) and a mesh fabric material 30 having a plurality of meshes 32 disposed on the mesh fabric material 30 are prepared as shown in FIGS. 1 and 2. The portion having no meshes 32 is a sealed fabric surface 31, and the non-meshed area facing the foam material 10 is a fabric surface 311.

Pre-foaming: The foam material 10 is foamed till it is foamed incompletely to a specific range such as 70˜80%, and thus the surface is slaked, and then the slaked surface is removed.

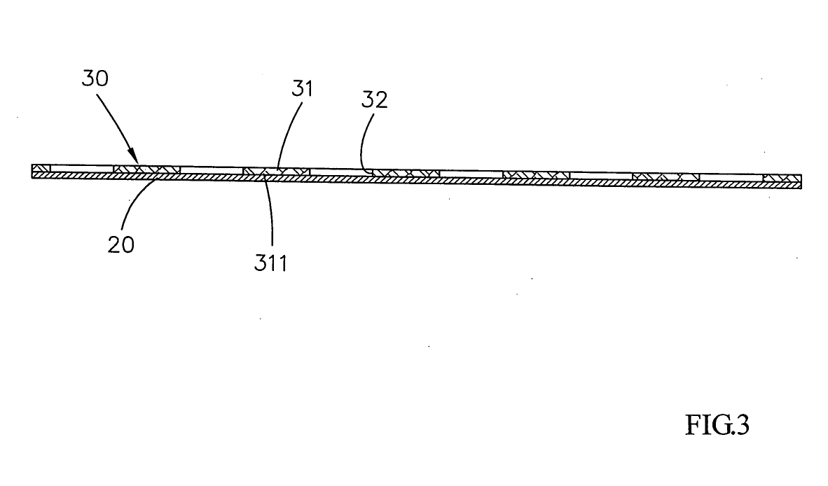

Printing Ink Layer: A printing ink layer 20 having a predetermined pattern with different colors and sizes is coated onto a side of the fabric surface 311 of the mesh fabric material 30, wherein the side of the mesh fabric material 30 faces the side of the foam material 10 as shown in FIG. 3.

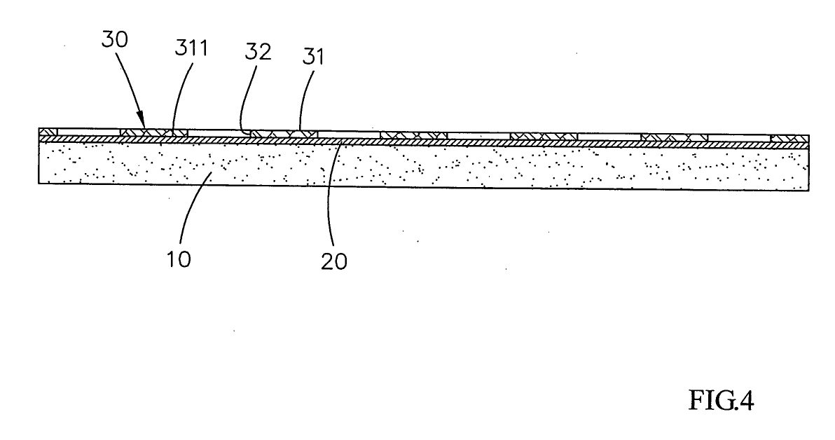

Hot Pressing: The foam material 10, mesh fabric material 30 and printing ink layer 20 are hot pressed as shown in FIG. 4, such that the heat will continue foaming the incomplete foamed material 10, while the color ink molecules of the printing ink layer 20 are sublimated due to the temperature and permeated into the porous tissues of the foam material 10 to fill the meshes on the surface of the foam material 10. Further, the sublimated moving molecules of the printing ink layer 20 will be filled into meshes 32 on the fabric surface 311, the internal walls of the meshes 32 and the gap of the foam material 10 and permeated into the porous tissues of the foam material 10.

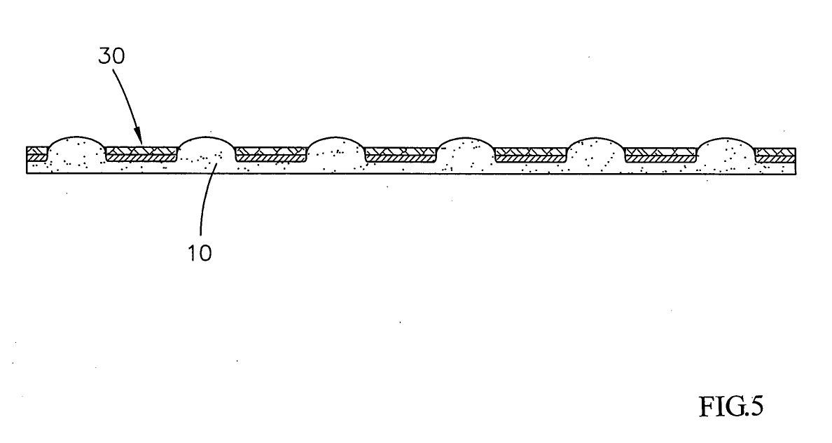

Referring to FIGS. 4 and 5, the foam material 10 continues foaming in the hot pressing process, and the fabric surface 31 shelters the foam material 10, such that the foaming pressure of the foam material 10 compresses the space of the meshes 32, and the foaming pressure of the foam material 10 is released towards the meshes 32. After the foaming is completed, protrusions 12 are formed at the meshes 32. The size of the protrusions 12 can be adjusted to fit the meshes 32. The larger the mesh 32, the smaller is the surface tension, and the larger is the protrusion 12, or else the smaller is the protrusion. The foam material 10 has already been foamed to a specific level, and thus further foaming is very limited, and the foam material 10 will be forced out of the meshes 32. As a result, an appropriate foaming can be achieved, and the particle size can be maintained evenly, orderly and fully.

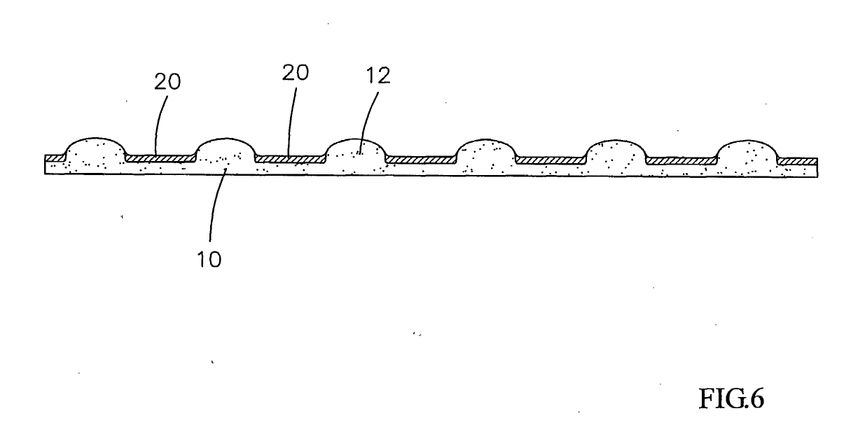

Tearing Away Mesh Fabric Material: The mesh fabric material 30 is torn away as shown in FIG. 6, after the printing ink layer 20 is coupled with the foam material 10 and the printing ink layer 20 is dried, so that the mesh fabric material 30 is separated from the foam material 10 and the printing ink layer 20.

Shaping: After the mesh fabric material 30 is torn away as shown in 6 and 7, the foam material 10 will show a pattern of the printing ink layer 20, and the range of the printing ink layer 20 excluding the protrusions 12 falls in the range of the visible color pattern on the protrusions 12 at a side of the foam material 10, so as to complete the flow of the method of the invention.

In the method of the invention, a single mold is used to produce a large chuck, and then the large chuck is cut into smaller pieces according to the size of the products or a continuous rolling pressing method is sued for the production.

The present invention can include the printing ink layer 20 by the mesh fabric material 30 and the foam material 10, such that the heated and pressed molecules of the printing ink layer 20 will flow towards the porous tissues of the foam material 10 to constitute a permeation to imprint the printing ink layer 20 onto the foam material 10 as an integral part instead of a connected layer. As a result, the printed foam material 10 will not be cracked or mottled on the printing ink layer 20 after the foam material 10 has been pulled or contracted for many times, so as to maintain the artistic look.

Referring to FIGS. 1 and 2, a second embodiment of the present invention is disclosed and comprises the following steps:

Preparing materials: a foam material 10 such as ethyl vinyl acetate (EVA), thermal plastic elastomer (TPE), polyurethane (PU) or styrene (SBR) and a mesh fabric material 30 having a plurality of meshes 32 disposed on the mesh fabric material 30 are prepared as shown in FIGS. 1 and 2. The portion having no meshes 32 is a sealed fabric surface 31, and the non-meshed area facing the foam material 10 is a fabric surface 311.

Pre-foaming: The foam material 10 is foamed till it is foamed incompletely to a specific range such as 70˜80%, and thus the surface is slaked, and then the slaked surface is removed.

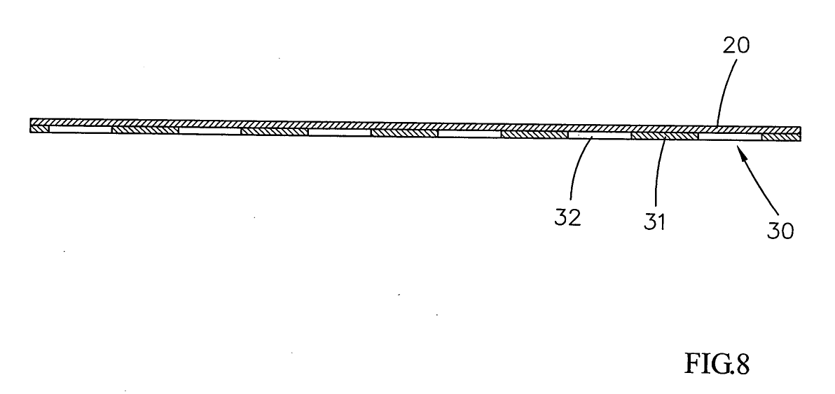

Printing Ink Layer: A printing ink layer 20 having a predetermined pattern with different colors and sizes is coated onto a side of the fabric surface 311 of the mesh fabric material 30, wherein the side of the mesh fabric material 30 faces the other side of the foam material 10 as shown in FIG. 8.

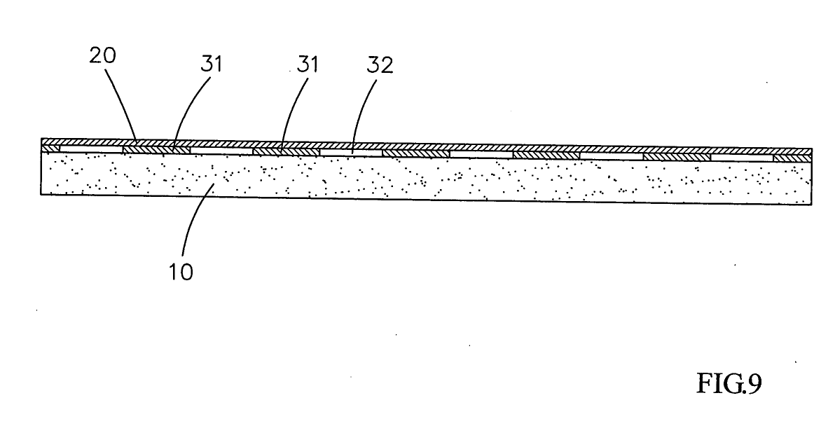

Hot Pressing: The foam material 10, mesh fabric material 30 and printing ink layer 20 are hot pressed as shown in FIG. 9, such that the heat will continue foaming the incomplete foamed material 10, while the color ink molecules of the printing ink layer 20 are sublimated due to the temperature and permeated into the porous tissues of the foam material 10 to fill the meshes on the surface of the foam material 10. Further, the sublimated moving molecules of the printing ink layer 20 will be filled into the protrusions 12 on the fabric surface 311, and the gap of the foam material 10 and permeated into the porous tissues of the foam material 10.

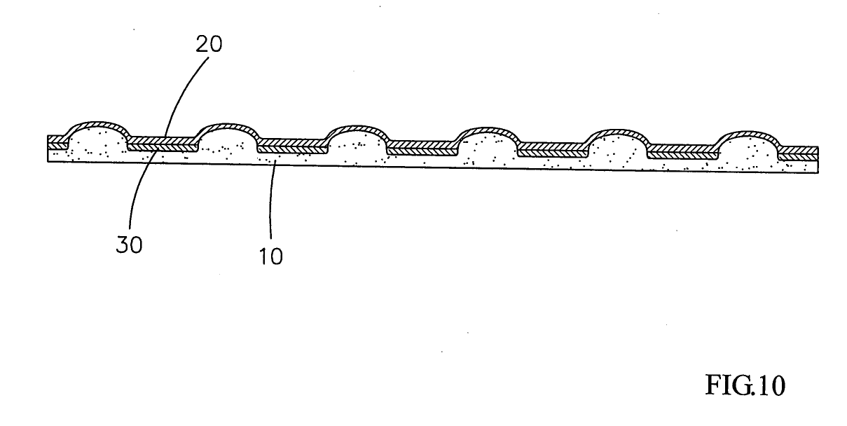

Referring to FIGS. 9 and 10, the foam material 10 continues foaming in the hot pressing process, and the fabric surface 31 shelters the foam material 10, such that the foaming pressure of the foam material 10 compresses the space of the meshes 32, and the foaming pressure of the foam material 10 is released towards the meshes 32. After the foaming is completed, protrusions 12 are formed at the meshes 32. The size of the protrusions 12 can be adjusted to fit the meshes 32. The larger the mesh 32, the smaller is the surface tension, and the larger is the protrusion 12, or else the smaller is the protrusion. The foam material 10 has already been foamed to a specific level, and thus further foaming is very limited, and the foam material 10 will be forced out of the meshes 32. As a result, an appropriate foaming can be achieved, and the particle size can be maintained evenly, orderly and fully.

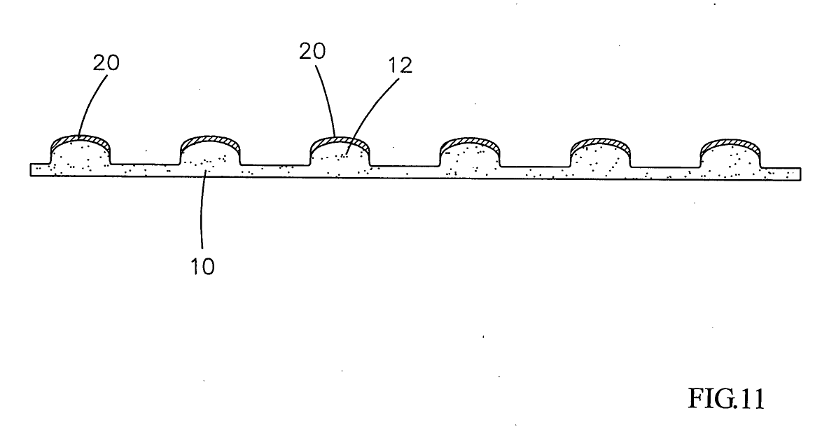

Tearing Away Mesh Fabric Material: The mesh fabric material 30 is torn away as shown in FIG. 11, after the printing ink layer 20 is coupled with the foam material 10 and the printing ink layer 20 is dried, so that the mesh fabric material 30 is separated from the foam material 10 and the printing ink layer 20.

Shaping: After the mesh fabric material 30 is torn away as shown in 11 and 12, the foam material 10 will show a pattern of the printing ink layer 20, and the range of the printing ink layer 20 excluding the protrusions 12 falls in the range of the visible color pattern on the protrusions 12 at a side of the foam material 10, so as to complete the flow of the method of the invention.

In summation of the description above, the object, shape, structure of the present invention are novel and the invention improves over the prior art and thus is duly submitted for the patent application. While the invention has been described by means of specific embodiments, modifications and variations could be made by those skilled in the art without departing from the scope and spirit of the invention set forth in the claims.

What is claimed is:

1. A foam imprinting method, comprising the steps of:
preparing a foam material and a mesh fabric material having a plurality of meshes thereon, and the portion of said mesh fabric material having said meshes being a fabric surface;
pre-foaming said foam material till said foam material is not completely foamed;
printing a printing ink layer onto said fabric surface on a side of said mesh fabric material facing said foam material;
printing ink layer onto the fabric surface;
hot pressing said foam material, said mesh fabric material and said printing ink layer, such that said printing ink layer is permeated and imprinted onto said foam material, and a protrusion is formed at said meshes of said foam material due to its foaming; and
tearing away said mesh fabric material from said foam material, after said printing ink layer is imprinted, so as to complete the process of imprinting a pattern onto said foam material.

2. The foam imprinting method of claim 1, wherein said pre-foaming process foams said foam material substantially to a level of 50˜80%.

3. The foam imprinting method of claim 1, further comprising the steps of: removing a slaked surface; and pressing said mesh fabric material of said printing ink layer together after said pre-foaming step is completed.

4. The foam imprinting method of claim 1, wherein the ink layer is printed on the side of the mesh fabric material facing the foam material.

5. The foam imprinting method of claim 1, wherein the ink layer is printed on the side of the mesh fabric material facing the other side of the foam material.
